(19) United States
(12) Patent Application Publication
(10) Pub. No.: US 2002/0147660 A1
(43) Pub. Date: Oct. 10, 2002

(54) Scheduling, tracking, and synchronization of events with personal portable computers using bar code data input

(76) Inventor: Bernadette Indence, Northport, NY (US)

Correspondence Address: Daniel R. McGlynn, Symbol Technologies, Inc., One Symbol Plaza, MS-A-6, Holtsville, NY, 11742, US

(21) Appl. No.: 09/829,800

(22) Filed: Apr. 10, 2001

(51) Int. Cl. G06F 17/60

(52) U.S. Cl. 705/26

(57) ABSTRACT

A bar code reader initiated method in which a mobile computer with a bar code reader having an internally stored user identification, reads a bar code symbol, processes the data from the bar code symbol and the user identification into a message, and automatically transmits the message over a wireless communication link connected to a network according to a registry server where certain events or transactions can be scheduled and tracked. The message is received at a registry server, on the network, where the symbol data and the user identification information is processed and stored. When the user contacts the server at a later date, the mobile computer is updated or sychronized with the new data at the registry server based upon the processing that has occurred since the last association, including reminders concerning scheduled events.

### 1. FIELD OF THE INVENTION

The apparatus and methods consistent with the present invention relate to personal portable or mobile computers having a bar code reader, and more particularly to the configuration software, Internet registry servers, and communications protocols needed to support scheduling, tracking, and synchronization services from the bar code reader computer to other network sites, and end-users accessible in such networks, especially for consumer applications.

### 2. BACKGROUND OF THE INVENTION

One type of mobile computer or terminal incorporates a bar code symbol reader and is now in very common use for data collection applications. Typically, a bar code symbol comprises one or more rows of light and dark regions, typically in the form of rectangle. The relative widths of the dark regions, i.e., the bars and/or the widths of the light regions, i.e., the spaces, between the bars encode data or information in the symbol.

A bar code symbol reader illuminates the symbol and senses light reflected from the regions of differing light reflectivity to detect the relative widths and spacings of the regions and derive the encoded information. Bar code reading type data input systems improve the efficiency and accuracy of data input for a wide variety of applications. The ease of data input in such systems facilitates more frequent and detailed data input, for example to provide efficient taking of inventories, tracking of work in progress, etc.

A variety of reader types are known. One particularly advantageous type of reader is a laser scanner which scans a beam of light, such as a laser beam, across the symbol. Laser scanner systems and components of the type exemplified by U.S. Pat. Nos. 4,387,297 and 4,760,248 which are owned by the assignee of the instant invention and are incorporated by reference herein have generally been designed to read bar code symbols, such as the Universal Product Code (UPC) type, at a certain working range or reading distance from the unit.

Wireless local area networks use infrared or radio frequency communications channels to communicate between portable or mobile computer terminals and stationary access points or base stations. These access points are in turn connected by a wired (or possibly wireless) communication channel to a network infrastructure which connects groups of access points together to form a local area network, including, optionally, one or more servers or host computer systems.

Wireless and radio frequency (RF) protocols are known which support the logical interconnection of portable terminals having a variety of types of communication capabilities to host computers. The logical interconnections are based upon an infrastructure in which at least some each of the terminals are capable of communicating with at least two of the access points when located within a predetermined range therefrom, each terminal unit being normally associated with and in communication with a single one of such access points. Based on the overall spatial layout, response time, and loading requirements of the network, different networking schemes and communication protocols have been designed so as to most efficiently regulate the communications between a given terminal and the network through the selected access point. One such protocol is set forth in the ISO/IEC 8802-11, or ANSI/IEEE Std 802.11 entitled “Wireless LAN Medium Access Control (MAC) and Physical Layer (PHY) Specifications” (1999 edition) available from the IEEE Standards Department, Piscataway, N.J. (hereinafter the “IEEE 802.11 Standard”).

Prior to the present invention, there has not been a simple, automatic data entry technique which would allow a personal user of a portable digital assistant or mobile computer to read a bar code symbol and use that data for scheduling, and tracking future events, utilizaing a wireless local area network, the Internet, a registry server on the network; and other network channels to different destination stations.

### SUMMARY OF INVENTION

1. Objects of the Invention

It is a general object of the present invention to provide a mobile computer with a personal scheduling and tracking software protocol and a network architecture using a mobile bar code symbol reader as a data entry device.

It is another object of the invention to provide a method for scheduling transactions and messages with other stations in a network using bar code data entry in a mobile computer terminal.

It is a further object of the present invention to provide a service to consumers using a portable bar code reader terminal, a wireless personal area network or LAN, and an Internet server for scheduling and tracking events, and notifying the consumer and other addressable stations in the network at scheduled intervals as determined by bar code data input entered at the terminal.

It is another object of the present invention to provide a network station accessed from a wireless LAN and a communications gateway that maintains sychronization of a mobile computer from network to network, and at different usage intervals.

It is an even further object of the invention to provide a method which can be used to accomplish one or more of the above objectives.

Additional objects, advantages and novel features of the present invention will become apparent to those skilled in the art from this disclosure, including the following detail description as well as by practice of the invention. While the invention is described below with reference to preferred embodiments, it should be understood that the invention is not limited thereto. Those of ordinary skill in the art having access to the teachings herein will recognize additional applications, modifications and embodiments in other fields, which are within the scope of the invention as disclosed and claimed herein and with respect to which the invention could be of significant utility.

2. Features of the Invention

The present invention provides a method for providing synchronization information to a mobile unit by reading a bar code symbol with a bar code reader mobile computer having a user identification; processing the data from the bar code symbol including the symbol data and the user identification; transmitting the data over a wireless communication link; receiving the data at a registration server on a network; processing the symbol data and the user identification information to determine information to be obtained from suppliers or sources on the networks; and transmitting an such information to the mobile unit and to specified destination station over the network.

The invention further provides a method for using a portable digital assistant or mobile unit with a bar code reader to facilitate scheduling events, notification, or transactions between a buyer and at least one of a plurality of sellers of a product or service, utilizing a computer network, by reading a bar code symbol to input into a data base record in the portable digital assistant information with respect to a date, a product or service, and a recipient; and transmitting a registry request with the record over a computer network to a registry site on the network. At the registry search, a search engine may determine the potential suppliers on the network capable of providing the product or service identified in the record. The search engine may then transmit an inquiry over the network to the identified potential suppliers to determine the price and availability of the product or service. The registry site receives responses to the inquiry from one or more potential suppliers; and transmits the responses at a predetermined schedule to the user of the portable digital assistants.

The novel features and characteristics of the invention are set forth in the appended claims. The invention itself, however, as well as other features and advantages thereof, will be best understood by reference to a detailed description of a specific embodiment, when read in conjunction with the accompanying drawings.

### DESCRIPTION OF DRAWINGS

FIG. 1 is a perspective view of one embodiment of a mobile unit that may be utilized by the present invention;

FIG. 2 illustrates a block diagram of the mobile unit;

FIG. 3 illustrates a network environment in which the present invention can be implemented;

FIG. 4 illustrates a process flow diagram of a scheduling system according to the present invention;

FIG. 5 illustrates a screen shot of the display in the mobile unit depicting a form or template which allows a user to enter data by bar code scanning for use in a message;

FIG. 6 illustrates a screen shot of the display depicting a response from the registry server to the user.

Like reference symbols in the various drawings indicate like elements.

### DESCRIPTION OF THE PREFERRED EMBODIMENT

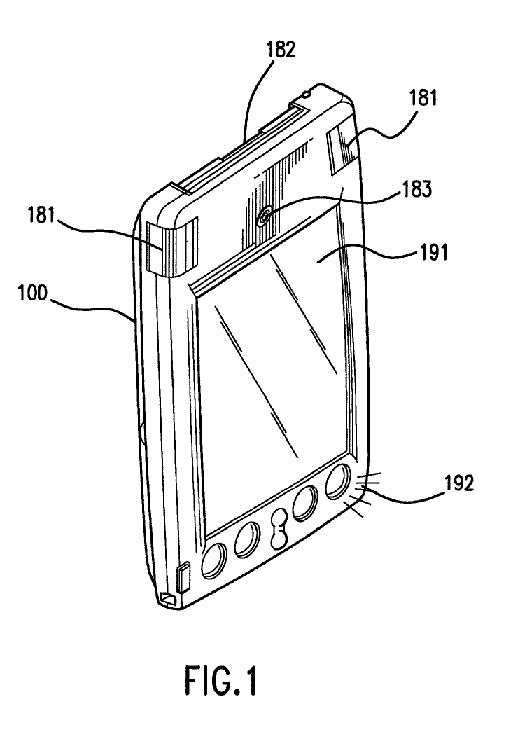

Devices known as portable digital assistants, or small mobile computers intended for personal use, are now very well known. Referring to FIG. 1, there is depicted a perspective view of one model of a mobile computer designed to be held in the hand of the user which incorporates a bar code reader that may be used in practicing the present invention. More particularly, computer 100 incorporates trigger switches 181 on either side of the unit designed to activate the bar code reader 182. The computer further may include a microphone 183, a speaker 192, function keys 193, and a touch screen display 191.

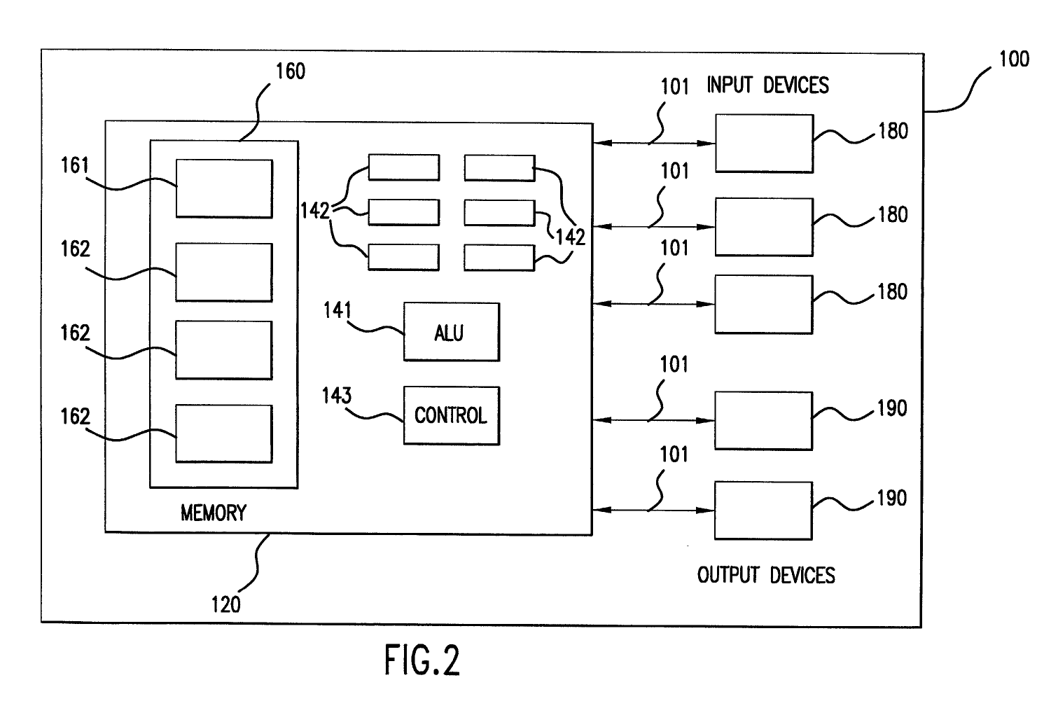

Referring to FIG. 2, in highly simplified block diagram form, illustrates a mobile computer unit 100 with a computer subassembly 120 that comprises at least one high speed processing unit 140 (CPU), in conjunction with a memory subsystem 160, an input device 180, and an output device 190. These elements are interconnected by a bus structure 101.

The illustrated CPU 140 is of standard design and includes an ALU 141 for performing computations, a set of registers 142 for temporary storage of data and instructions, and a control unit 143 for controlling input/output and operation of the unit. Any of a variety of processors, including those from Motorola, NEC, Intel, Cyrix, AMD, Nexgen and others are equally preferred for CPU. Although shown with one CPU, the computer subassembly system may alternatively include multiple processing units.

The memory subsystem 160 includes main memory 161 and secondary storage 162. The illustrated main memory 161 is high speed random access memory (RAM) and read only memory (ROM). Main memory 161 can include any additional or alternative high speed memory device or memory circuitry. Secondary storage 162 takes the form of long term storage, such as ROM, optical or magnetic disks, or any other volatile or non-volatile mass storage system. Those skilled in the art will recognize that memory can comprise a variety and/or combination of alternative components.

The input and output devices 180 and 190 are also standard The input device 180 can comprise a keyboard, keypad, touch screen, trigger switch, buttons, bar code reader, mouse, track ball device, audio device (e.g., a microphone, etc.), or any other device providing input to the computer unit. The output device 190 can comprise a display, such as a liquid crystal display (LCD), a printer, an audio device (e.g. a speaker, etc.), or other device providing output for the computer unit. The input and output devices can also include radio transceivers, network connections, modems, or other devices used for communications with other computer units or devices, which is a key feature of one embodiment of the invention.

The mobile unit 100 is provided with operating system software. In an embodiment, the operating system can be Windows 9x , Windows 2000, CE or NT platforms. In other embodiments, the operating system can be Mac OS, Palm OS, or Linux. In one embodiment, the memory 161 can be random access memory into which the operating system is loaded. In another embodiment, the memory 162 can be any type of firmware such as EPROM or EEPROM into which the operating system is “burned”.

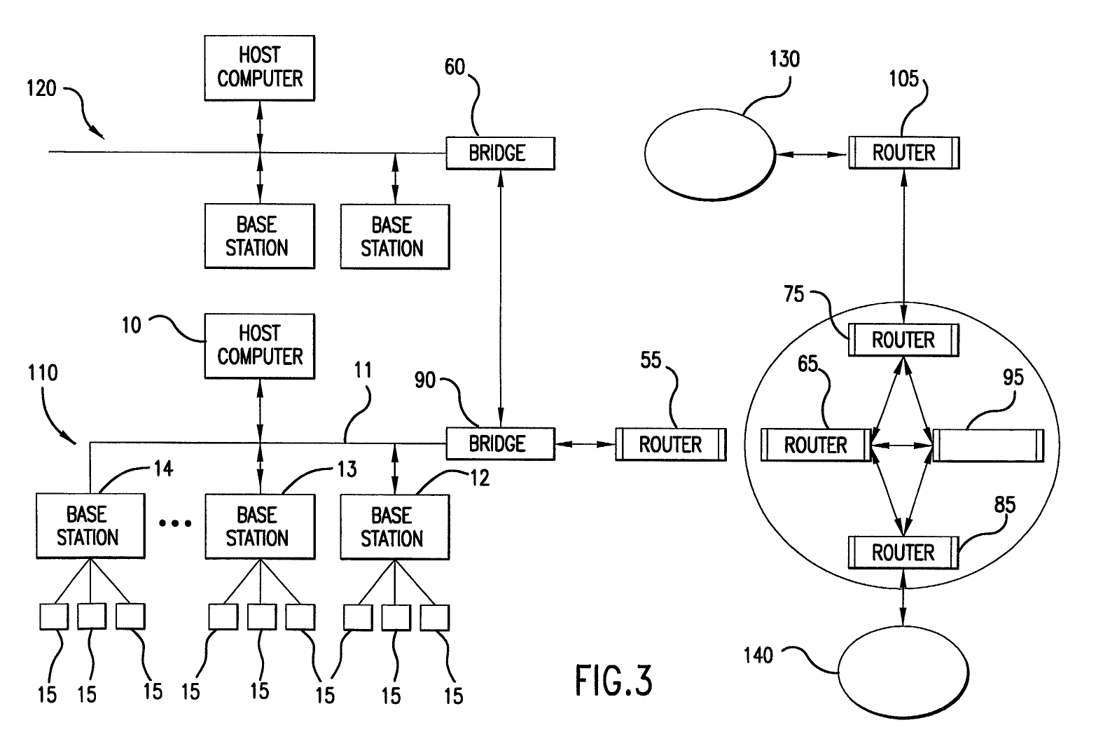

FIG. 3 shows a diagrammatic representation of a typical networking environment consistent with the present invention in a preferred embodiment of the home, small office, school, or similar public or private space. The physical hardware components reside at the lowermost OSI layer, or physical layer, and include various nodes distributed along the network link or cabling. Although the term “node” broadly refers to all types of physical devices attached to the network link, only client and server nodes are depicted in FIG. 3.

More specifically, FIG. 3 illustrates clients and servers interconnected through a network link, although additional clients and servers, as well as other types of nodes, may be distributed along the network link as well. As used in this specification, the term “client” will generally denote a peripheral device or network appliance of some type associated with a user. The term “server” includes any device directed for controlling and coordinating shared usage of an network resource, such as an access point, or website content or data source.

FIG. 3 shows a data communications network according to one embodiment of the invention. A first local area network 110 is illustrated, which is a preferred embodiment includes a host processor 10 connected by a wired communications link 11 to a number of stationery access points or base stations 12,13; other base stations 14 can be coupled to the host through the base stations or by an RF link. Each one of the base stations 12,13,14 is coupled by an RF link to a number of remote portable mobile units 15. In one embodiment, the portable mobile units 15 are hand-held, battery-operated data terminals, pagers, or voice communication handsets such as depicted in FIG. 1 or described in U.S. Pat. Nos. 5,029,183; and 6,119,944 all assigned to Symbol Technologies, Inc., and each incorporated herein by reference.

In addition to the architecture shown if FIG. 3, wide area networks, cellular networks, or other wireless internetworking nodes may also be used. On such network is described in U.S. Pat. No. 5,901,362 of IBM, which is hereby incorporated by reference and similar ad-hoc networks without fixed or base stations are also within the scope of the present invention.

Although hand-held, laser scanning bar-code reader data terminals are the preferred mobile unit, the data terminals may also include bar-code readers of the CCD or wand type, and may be portable or stationery or worn by the user rather than hand-held. The mobile units 15 may also function as voice communication handsets, pagers, still image or video cameras, cellular telephones, AM/FM radio broadcast receivers, or any combination of the foregoing. Other types of data gathering devices may be utilized as terminals and use the scheduling features of the invention, such as temperature, pressure, or other biophysical or environmental measuring devices, event counters, voice or sound activated devices, intrusion detectors, etc.

Various other types of portable terminals may be advantageously employed in a system having features of the invention; these portable terminals ordinarily could utilize data entry media such as keyboards, touchscreens, a magnetic cards, RFID tags, biometric sources, SIM devices, smart cards, electronic key (e.g. “Ving”) access cards, or the, like, as well as a display (or printer) for providing a display of the information detected, transmitted and/or received by the terminal. In this embodiment used as an illustrative example, there may be from one up to sixty-four of the base stations (three stations being shown in the Figure) and up to several hundred of the remote portable units; of course, the network is scalable and may be expanded by merely changing the size of address fields and the like in the digital system, as will appear, but a limiting factor is the RF traffic and attendant delays in waiting for a quiet channel.

The first LAN 110 may be coupled to additional LANs 120, 130, 140 etc. through controllers such as bridges 60, 90, etc. or routers 55, 65, 75, 85, etc.

The network may also include a registry server 95 which may be associated with an Internet site, and may include a plurality of software components that can be accessed by an agent program. Such components may include one or more object classes including applets, servlets, Java Beans (TM) etc. or in general any executable unit of code.

The server may be a directory server or standard database management system. The server 95 may include facilities for address translation, formatting, storage, and sychronization of data between the server 95 and the mobile unit 100 whenever the mobile unit accesses the server.

The communications networks, as depicted in FIG. 3, may also ordinarily be used in retail establishments, shopping malls, or like commercial or public facility, or combination of these facilities, where mobile units would be used to read bar codes on merchandise on display which the user may wish to consider purchasing through the registry site, for comparison shopping, and for delivery to the designated recipient.

In one aspect of the present invention, the server 95 may manage product search requests to be sent to one or more vendors, which sends product offers to the user. Such a product selection application will be described in greater detail subsequently.

The present invention is implemented by application programs included in the operating system of the mobile computer. One such application according to the present invention is a scan data entry and scheduling program. Such an application program derives data from scanning a bar code symbol, and places it in a data record field in a message for automatic transmission e.g. by the RF transceiver to the server 95. A key aspect of the present invention is that such operations may be done automatically through the use of a registry data entry program in which a profile has been created to automatically transmit the data to the registry website for further processing at a server 95, such as for deriving destination addresses and processing with a search engine. This program can enable a user to store requests for numerous events such that when a user turns on the mobile unit, the program automatically communicates with the server 95, loads the updated configuration parameters and data base information, so that the mobile unit is fully sychronized.

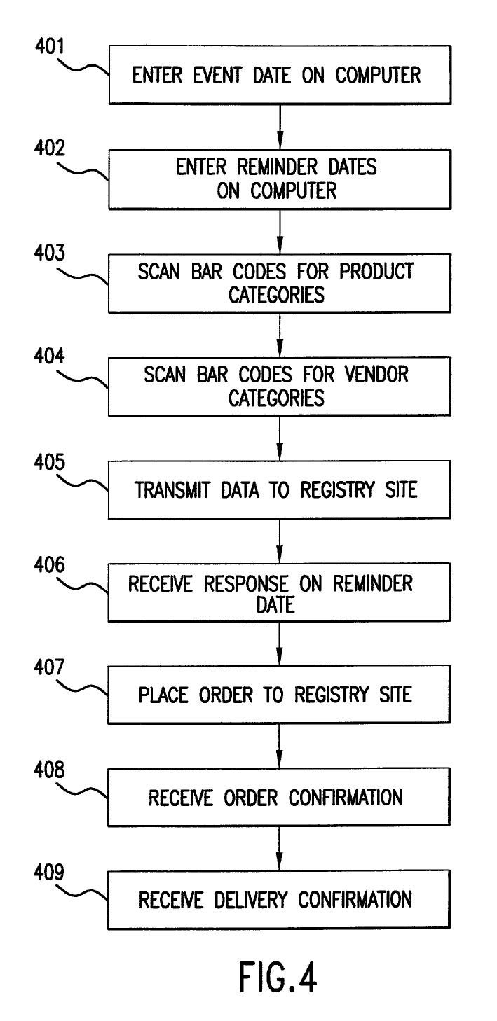

FIG. 4 depicts the process flow of an application program that may be executed on the mobile computer ti implement the present invention. A data entry template or profile is presented on the display of the mobile unit for the scan data entry and scheduling operation. The user first enters the event date into the computer, at 401. To use a simple consumer application, the event may be a friend's birthday. Next, reminder dates, prior to the event date, are entered 402. The user then scans one or more bar code symbols, from products, catalogs, or other media, to identify a product category, at 403. Price or vendor categories may also be selected by scanning similar bar codes for a price list, or vendor catalog 404. Once the profile is completed, the user presses a “submit” button or key, and template data is transmitted to a registry site, 405.

The present invention provides an automated method of communications from the mobile user when a particular scanned source data, such as a bar code symbols associated with products, is read and submitted, in a message also including a specific user ID. Associated with the mobile unit 15 is a unique address, which for purposes of discussion may be a temporary IP address. The method contemplates that the data from the bar code symbol, the user ID and IP addressis sent as a message over a wireless network, such as network 110 in FIG. 3, to a server, such as server 95 in FIG. 3. The server 95 functions to process and store the message, and determine what further action to be taken in the form of sending search requests to destination stations. For example, the server will include a database with cross-reference information to associate an input user ID with the most current IP address associated with the user, as the user moves at a later time to a different network.

Returning to FIG. 4, the server functions to track the reminder dates, and to obtain information on the requested products through use of search engines by the reminder date. When the user accesses the wireless on or shortly before the reminder date, the application program in the mobile unit will once again access the server 95 in order to receive a response, 406. Of course, since the user is in a new network, with a new IP address, the server 95 has to utilize its own database to access the requested information by user ID rather than IP address.

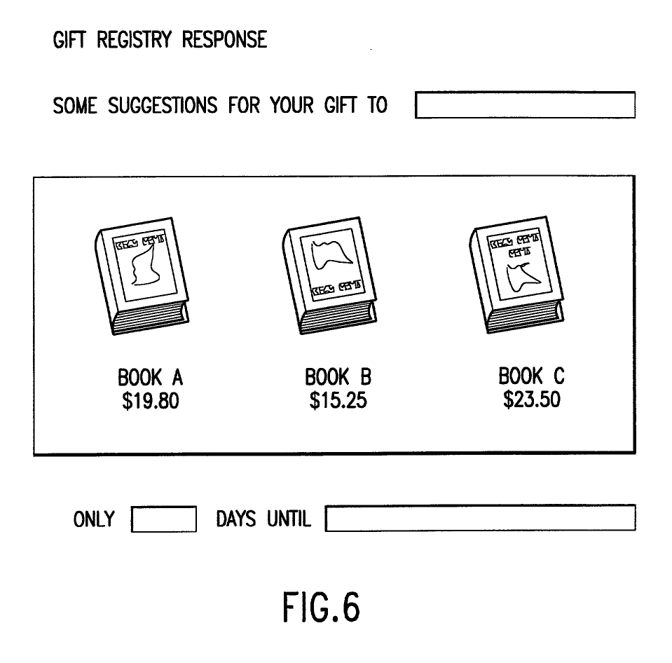

If the application is a transaction oriented one, the user may be informed of product offers corresponding the products or categories selected and input at 403 and 404. FIG. 6 depicts one example of a response that may be presented to the user, allowing the user to select from various product offerings in a particular category. In such an application, the user may place an order through the registry site, 407; the registry site can forward the order to the vendor, who will confirm it directly with the user, 408. On or before the event date, or delivery date, the vendor will deliver the product to the designated recipient *e.g., the birthday gift for user's friend). The user will receive confirmation of the delivery, 409.

The registry server 95 may function as an intelligent agent to forward product inquiries to different web sites or vendors, over different networks. The server may be a host on a wired network or Internet, and may be collocated with an access point on wireless local area network. The date processed may include the information read from the bar code symbol, the user ID and IP address, text information added by the user on the mobile unit 15, such as a description of the product (color, size, price range, etc.), using standard forms of text or other content provided by the server as part of the product search service. Such data may be provided to the destination station through a local area network, wide area network, cellular radio telephone service, or over the Internet. The data may be provided in any standard format, including HTML script. Alternatively, a URL could be provided to the destination station with appropriate query strings to allow the destination station to access a page at the server website over the Internet containing the description of the desired products.

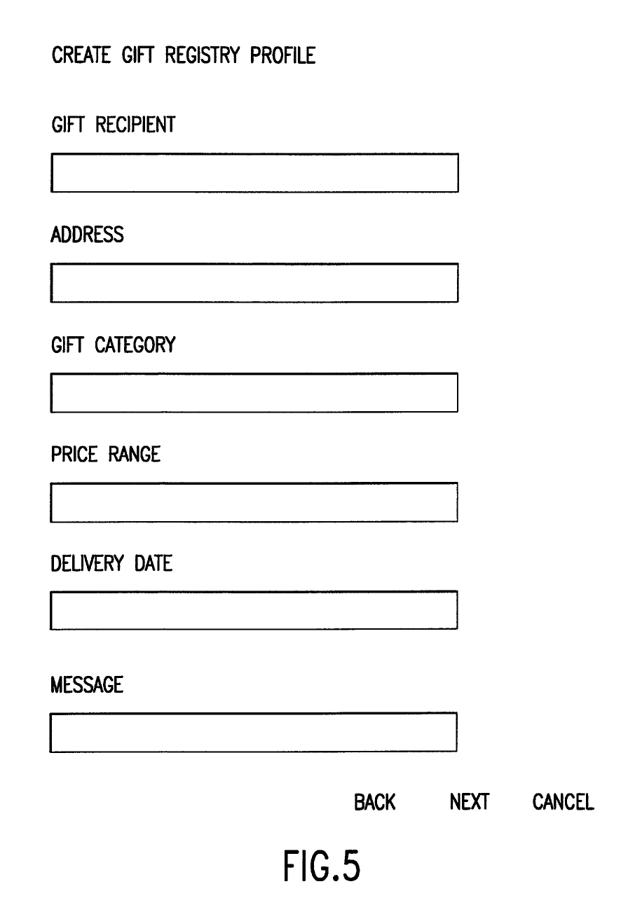

FIG. 5 depicts a screen shot of a display of the mobile computers using the scan data entry profile according to the present invention. One of the application programs included in the operating system of the mobile unit is a profile creation program which allows the user to specify the options to be utilized for subsequent scanning operations. Using various menu operations, as is well known in the art, the user specifies the profile of message options to be used. Based upon the profile selected, the user then selects parameters for specific profile entries. Once the profile has been completed, the profile is stored in the mobile unit as a form or template, and is ready to be activated and completed when the bar code symbols are scanned. For example, the user may activate the scanning operation by pressing a trigger switch on the unit, or otherwise initializing the scanning of a bar code symbol by the keypad of the mobile unit, and the scan data entry program will be initialized. Bar code symbols are then scanned by the user in a certain sequence, typically as defined by the display on the mobile unit, and such scanned sequence of bar codes provides the data which is automatically entered into data entry field locations on the form or template. The completed template is displayed, as has been previously specified according to the selected profile, e.g. product category, vendor, etc.

Once all of the data for the form has been completely entered by appropriate scanning of bar codes, the data is automatically transmitted over the wireless link to the server, 95. The profile already has knowledge of specified the server location and communication address so that such transmission occurs transparently to the user. Once the server 95 receives the message and acknowledges receipt back to the mobile unit, the process is completed. The user can then utilize the mobile unit for other operations or alternatively, if the same application program is to be utilized for different event schedules and reminder data entries, the appropriate profile can then be accessed once again, and the process reinitiated for a different profile and a different set of bar code scanned data entries.

Although the illustration of the screen shot with the profile and scan data entry parameters chosen for a typical customer inquiry application is purely exemplary, various other screen designs and window arrangement for conveying information to the user would be known to those skilled in the art. The key feature of the present invention is that various fields of the screen profile provided on the screen template or display are entered by the scanning of a bar code symbol containing encoded text or encoded data representing information to be placed in such template field or location. After such entry has been visually verified by the user on the display of the mobile unit, the user then is immediately able to transmit the message to the destination station by means of a single point and click, or pressing a function key or send button on the mobile unit. The automatic data capture of information through bar code reading, automatic entry of such information in sequential order in a form template presented on the screen, and the automatic transmission of such information over a wireless data link for scheduling events, reminders, and product searches selected by the user at the mobile terminal is an important aspect of the present invention which is believed to provide significant efficiency and time savings in the event scheduling applications contemplated for many different user applications related to recording products by scanning bar codes associated with such products.

Another feature of the present invention is to provide a graphical user interface which enables a user to develop a specify scanning, scheduling, or other reminder operational parameters for a mobile unit through the use of icons, buttons, meters, slides, or other objects implemented on a interactive display. For example, the present invention may also provide an interactive display to the user depicting a list of the vendors available. The user may define the priorities of selecting vendors by pointing and clicking, or drag and dropping, on such objects on the display as is well known in the art so as to achieve the desired schedule. One such architecture is specified by a user, it may be implemented as a software file and sent to the actual various vendors represented, along with activation schedules, to indicate the duration, context, or other bounds with which the notification service is to be configured to inform or alert the user for “sales” or other aspects of a transaction concerning a product.

Various aspects of the techniques and apparatus may be implemented in digital circuitry, or in computer hardware, firmware, software, or in combinations of them. Apparatus of the invention may be implemented in computer products tangibly embodied in a machine-readable storage device for execution by a programmable processor, or on software located at a network node or website which may be downloaded to the computer product automatically or on demand. The foregoing techniques may be performed, for example, single central processor, a multiprocessor, one or more digital signal processors, gate arrays of logic gates, or hardwired logic circuits for executing a sequence of signals or program of instructions to perform functions of the invention by operating on input data and generating output. The methods may advantageously be implemented in one or more computer programs that are executable on a programmable system including at least one programmable processor coupled to receive data and instructions from, and to transmit data and instructions to, a data storage system, at least one in/out device, and at least one output device. Each computer program may be implemented in a high-level procedural or object-oriented programming language, or in assembly or machine language if desired; and in any case, the language may be compiled or interpreted language. Suitable processors include, by way of example, both general and special purpose microprocessors. Generally, a processor will receive instructions and data from read-only memory and/or random access memory. Storage devices suitable for tangibly embodying computer program instructions and data include all forms of non-volatile memory, including by way of example, semiconductor devices, such as EPROM, EEPROM, and flash memory devices; magnetic disks such as internal hard disks and removable disks; magneto-optical disks; and CD-ROM disks. Any of the foregoing may be supplemented by or incorporated in, specially designed application-specific integrated circuits (ASICS).

It will be understood that each of the elements described above, or two or more together, also may find a useful application in other types of constructions differing from the types described above.

While the invention has been illustrated and described as embodied in a scanning mobile unit and registry server on a communications network, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

I claim:

1. A network based scheduling method, comprising:
reading a bar code symbol representing a product item with a bar code reader having an internally stored user identification;
processing the data from the bar code symbol together with user options, and the user identification into a scheduling task and transmitting the information on the task from the reader over a wireless communication link connected to a network;
receiving the message at a registry node on a network;
processing the symbol product data, scheduling task and the user identification information at the registry node to determine the potential vendors of the product item; and
transmitting a message to the user over the wireless network at the scheduled time determined by the user with product information from potential vendors.

2. The method of claim 1, wherein the registry node on the network is an Internet website.

3. The method of claim 1, wherein the message is in the form of a e-mail including the data from the bar code symbol.

4. The method of claim 1, wherein the e-mail includes information on the product item.

5. The method of claim 1, wherein the registry node includes a database containing product source information.

6. The method of claim 1, wherein the registry node on the network is an access point in a wireless local area network.

7. The method of claim 1, wherein the message is in the form of a HTML script.

8. The method of claim 1, further comprising providing access to a registry server network page through a URL containing the appropriate query strings necessary to present the appropriate page containing product features desired by a prospective purchaser to the destination station which is a prospective supplier of the product.

9. The method of claim 1, further comprising cross-referencing the user ID and the user's IP address at the registry node on each association.

10. A method for using a portable digital assistant and a bar code reader to facilitate scheduling events, notification, or transactions between a buyer and at least one of a plurrality of sellers of a product or service, utilizing a computer netework comprising:
reading a bar code symbol to input into a data base record in the portable digital assistant information with respect to a date, a product or service, and a recipient;
transmitting a registry request with the record over a computer network to a registry site on the network;
determining the potential suppliers on the network capable of providing the product or service identified in the record;
transmitting an inquiry over the network to the identified potential suppliers to determine the price and availability of the product or service;
receiving at the registry site responses to the inquiry from one or more potential suppliers; and
determining the current network location of the user and transmitting the responses at a predetermined schedule to the user.

11. A method as defined in claim 10, where the computer network is a wireless LAN.

12. A method as defined in claim 10, wherein the registry site completes a purchase transaction for the user by transmitting an acceptance to a potential supplier.

13. A method as defined in claim 10, wherein the step of determining the current network location of the user makes use of the stored user ID and the current IP address associated with the user ID.
